(19) United States
(12) Patent Application Publication
(10) Pub. No.: US 2021/0176518 A1
(43) Pub. Date: Jun. 10, 2021

(54) Digital Set-top Box with Custom Channel Function

(71) Applicant: Trans Electric Co., Ltd., Changhua Hsien (TW)

(72) Inventor: Ching Shen Hsiao, Changhua Hsien (TW)

(21) Appl. No.: 16/702,687

(22) Filed: Dec. 4, 2019

(51) Int. Cl. H04N 21/431; H04N 21/472; H04N 21/482; H04N 21/41

(52) U.S. Cl. CPC H04N 21/4312; H04N 21/41; H04N 21/482; H04N 21/47202

(57) ABSTRACT

A digital set-top box with a custom channel function has a central processing unit, including a composite channel table that has a channel list storing more than one channel number and more than one channel, wherein each of the channel numbers has a corresponding channel, and each of the channels is a video stream channel provided by a video streaming application installed in the central processing unit by the user; a memory unit, electrically connected to the central processing unit for storing the channels in the composite channel table; and an input/output unit, electrically connected to the central processing unit for receiving a control command sent from a remote control. When the remote control sends a number command, the central processing unit displays the channel corresponding to the channel in the number command on a display screen.

### BACKGROUND OF THE INVENTION

### 1. Field of the Invention

The invention relates to a digital set-top box and, in particular, to a digital set-top box that allows channel customization.

### 2. Description of Related Art

With the change of time, the signal source of cable TV has been gradually updated from conventional analog signals to digital signals, making digital set-top boxes more and more popular.

Compared with the conventional cable TV, the existing digital set-top box has the features of low signal distortion, high information quantity encoded in the signal, and being less susceptible to environmental influences. Consequently, the video provided by the digital set-top box is more subtle and clearer. Different channels have higher and uniform quality, and are less susceptible to noise interference.

However, the existing digital set-top box can only receive the digital signals provided by the television signal vendor. Users cannot add their favorite channels according to their own needs. In addition, even if the user wants to watch the video provided by a specific application, such as YouTube and Netflix, the existing digital set-top boxes cannot support such a function.

In addition, if a user wants to select a specific channel to view through the existing digital set-top box, he must click the direction key on the remote control or on the digital set-top box to switch to the specific channel. For example, if the current video is on channel 01 and the user wants to watch channel 50, he must press the direction key on the digital box set-top box one press at a time, and switch the channel through channel 01, channel 02, . . . , to channel 50. This is extremely inconvenient in practice. It may take a lot of time to switch to the desired channel.

### SUMMARY OF THE INVENTION

In order to solve the problems that the existing digital set-top box does not allow users to freely enter numbers for switching channels and that the user is not allowed to arbitrarily add and delete a channel, the invention proposes a digital set-top box with a custom channel function. By establishing a number for each channel and using a signal input unit to receive the installation file of a newly added channel, the user can directly enter the number corresponding to any channel on the remote control to switch to the channel, and the channel installation file is used to add the channel in the channel table.

To achieve the above objective, the invention provides a digital set-top box with a custom channel function, which is connected with a remote control and a display. The disclosed digital set-top box with a custom channel function includes:

a central processing unit, which includes a user editable composite channel table that stores more than one channel number and more than one channel, with each of the channel numbers corresponding to a respective one of the channels, wherein the channels in the composite channel table include television channels and a video stream channel provided by a video streaming application executed by the central processing unit, and each of the channel numbers has corresponding media setting information;

a signal input unit, electrically connected to the central processing unit and including a plurality of media ports for receiving different digital video sources;

an audio/video (AV) output unit, electrically connected to the central processing unit for outputting a video signal;

a memory unit, electrically connected to the central processing unit for storing each of the channels in the composite channel table and corresponding media setting information thereof;

an input/output (I/O) unit, electrically connected to the central processing unit for receiving a control command sent by the remote control; wherein when the remote control sends a number command, the central processing unit searches for the channel corresponding to the number command in the memory unit according to the number command and displays the channel on a display screen.

With the above components, the invention has the following enhancement effects:

1. The association between the channel number and the corresponding channel are established through the channel numbers and the channels stored in the channel list, so that each channel corresponds to a unique channel number. When a user enters one of the channel numbers through the remote control, the central processing unit switches to the channel corresponding to the channel number according to the channel number. Thus, the user can turn on the channel to be viewed more quickly, instead of wasting time on selecting the channel to be watched by frequently pressing the direction keys.

2. The plurality of media ports can each receive a different digital video source. Each of the video sources includes an application installation file from a web download or from an external storage device or a flash memory. The installation file installs the required application in the central processing unit, so that the user can watch other videos from other video sources in addition to the preset channels.

### BRIEF DESCRIPTION OF THE DRAWINGS

FIG. 1 is a schematic view of the circuit of the invention;

FIG. 2 is a schematic view of the composite channel table of the invention;

FIG. 3 is a first schematic view of the operation interface according to the invention; and

FIG. 4 is a second schematic view of the operation interface according to the invention.

### DETAILED DESCRIPTION OF THE PREFERRED EMBODIMENT

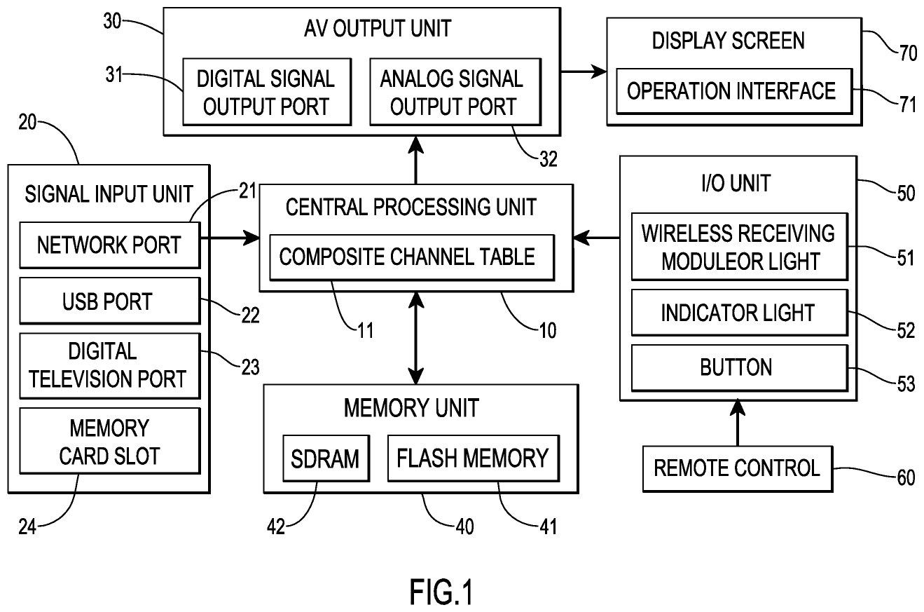

Referring to FIG. 1, the invention is a digital set-top box with a custom channel function, which can be connected and operated by an external remote control 60. The invention comprises: a central processing unit 10, a signal input unit 20, an AV output unit 30, and more than one memory unit 40, and is further provided with an I/O unit 50. The signal input unit 20, the AV output unit 30, the memory units 40, and the I/O unit 50 are electrically connected to the central processing unit 10, respectively.

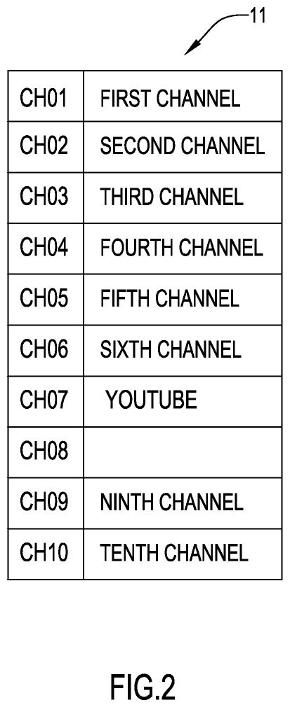

Please refer to FIG. 2. The central processing unit 10 presets a composite channel table 11 that can be edited by users and stores more than one channel number and more than one channel. Each channel number corresponds to a respective channel. The channels listed in the composite channel table 11 include television channels and video stream channels provided by a video streaming application executed by the central processing unit 10. The installation file of the video streaming application can be downloaded by the user via the network or obtained from an external storage device.

For example, channel number 01 corresponds to a first channel, channel number 02 corresponds to a second channel, and channel number 07 corresponds to a YouTube channel. The AV sources of the first channel and the second channel can be digital TV signals. The AV sources of the YouTube channels can be the web server of YouTube itself. Furthermore, the channels corresponding to the channel numbers can be set and changed according to the user. Taking FIG. 2 as an example, the YouTube channel is currently set to channel number 07 and channel number 08 is not yet associated with any specific channel. The user can unlink the YouTube channel from channel number 07 by setting and resetting the YouTube channel to channel number 08.

Furthermore, in this embodiment, each channel has its own media setting information. The media setting information may be a shortcut of a web address, a directory, a path, or media information. The media setting information is stored in the memory unit 40 and corresponds to each channel in the composite channel table 11. That is, each channel number corresponds to a unique media setting.

The signal input unit 20 can include a plurality of media ports, which respectively receive different digital video sources. In a preferred embodiment of the invention, the plurality of media ports can include more than one network port 21, more than one USB port 22, a digital television port 23, more than one memory card slot 24, and combinations thereof. Each network port 21 can be connected to an external network to download the installation file or directly capture the video signals. Each USB port 22 can be connected to the external storage device, such as a flash drive, that stores the installation file. The digital television port 23 can be connected to an external antenna or a digital television signal source for receiving multiple wired or wireless signals. Each of the memory card slots 24 allows the insertion of a flash memory card, which stores the installation file. The flash memory card includes, but is not limited to, a TF card (Micro SD card) or SD card.

The AV output unit 30 is configured to output a video signal. The AV output unit 30 may include more than one digital signal output port 31 and more than one analog signal output port 32, and outputs signals of the selected media port. The digital signal output ports 31 are configured to output a digital AV signal. The analog signal output ports 32 are configured to output an analog AV signal. In a preferred embodiment of the invention, the digital signal output ports 31 include an HDMI output port, an SPDIF output port, and a combination thereof. The analog signal output ports 32 include a CVBS output port, a D-SUB output port, an audio output port, and the combination thereof.

The memory unit 40 can include a flash memory 41 for storing the channels in the composite channel table 11 and their media setting information, and use the installation file to install the video streaming application therein. In a preferred embodiment of the invention, the memory unit 40 further includes a random access memory SDRAM 42 for temporarily storing the input of each port of the signal input unit 20. SDRAM 42 serves as a buffer for data buffering. The I/O unit 50 includes a wireless receiving module 51, a plurality of indicator lights 52 and a plurality of buttons 53 for receiving control commands from the remote control 60. In a preferred embodiment of the invention, the wireless receiving module 51 is an infrared (IR) receiving module, a Bluetooth receiving module or a Wi-Fi receiving module for receiving control commands from the corresponding remote control 60. The user can operate the remote control 60 to set the channels of the composite channel table 11 and the media setting information thereof. The indicator lights 52 are used to display the operating state of the central processing unit 10. The buttons 53 are available for the user to manually set the channels of the composite channel table 11 and the media setting information thereof.

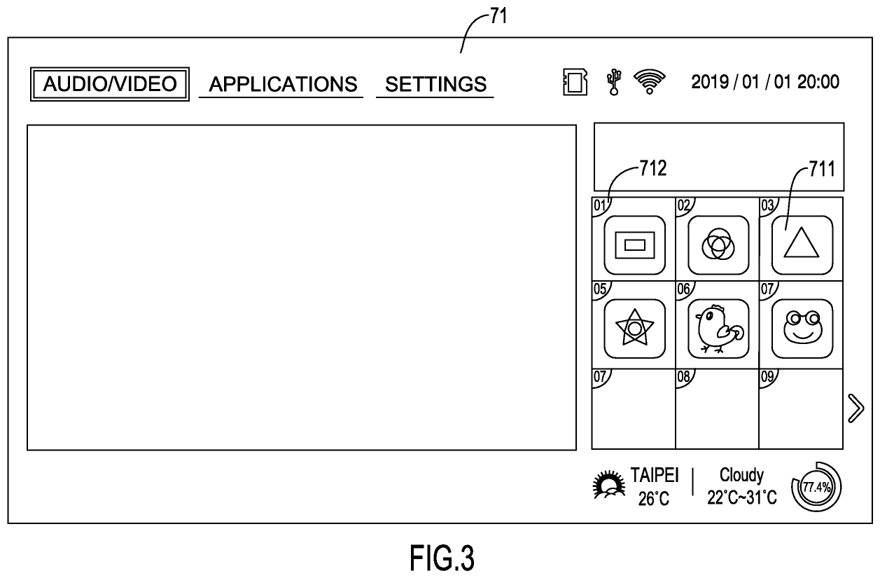

Referring to FIG. 3, the AV output unit 30 can be further connected to a display screen 70 in practice, and the central processing unit 10 can provide an operation interface 71 to transmit signals from the AV output unit 30 to the display screen 70. The operation interface 71 shows one icon 711 for the corresponding channel, and the channel number 712 corresponding to the channel is displayed next to the icon 711. Through the operation by the user, the remote control 60 sends a number command to the I/O unit 50. The/O unit 50 receives and transmits the number command to the central processing unit 10. The central processing unit 10 searches for the channel corresponding to the number command in the memory unit 40 according to the number command, and displays the channel on the display screen 70. Specifically, the central processing unit 10 searches for the media setting information corresponding to the number command in the memory unit 40 according to the number command, and displays the channel corresponding to the media setting information on the display screen 70. For example, when the user enters the number command 01 through the remote control 60, the central processing unit 10 searches for the channel corresponding to the number command 01 in the composite channel table 11 after receiving the number command 01. The central processing unit 10 then displays the first channel on the display screen 70 through the AV output unit 30.

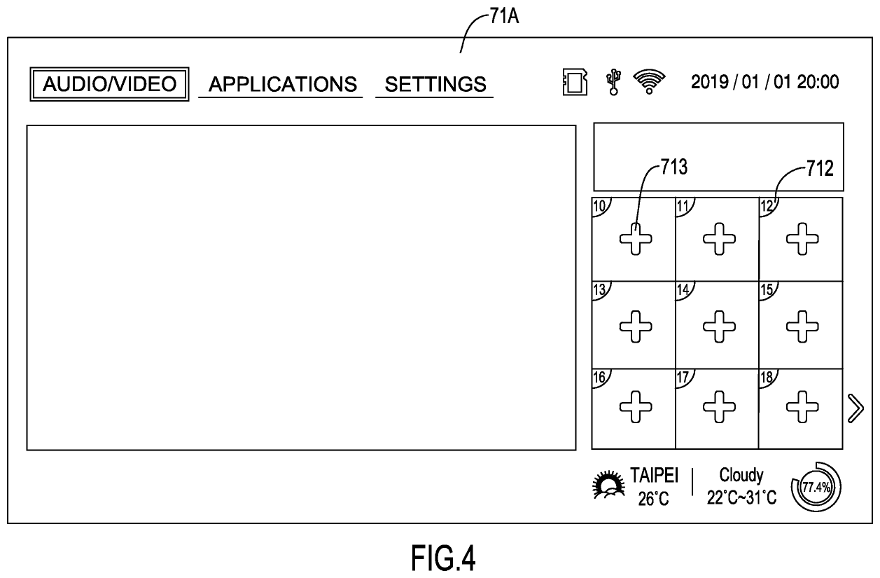

Please refer to FIG. 4. The central processing unit 10 can also expand the page of the operation interface 71. For example, the operation interface 71A in FIG. 4 can display the channel numbers 712 from 10 to 18. When a user selects to add one icon 713 on the operation interface 71A through the remote control 60, any other channel or video streaming application can then be added as one of the icons 711. Likewise, the user can also send the number command as the channel number 712 through the remote control 60 to turn on the self-defined channel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital set-top box with a custom channel function connected with a remote control and a display screen, comprising:
a central processing unit, which includes a user editable composite channel table that stores a plurality of channel numbers and a plurality of channels, with each of the channel numbers corresponding to a respective one of the channels, wherein the channels in the composite channel table include television channels and a video stream channel provided by a video streaming application executed by the central processing unit, and each of the channel numbers has corresponding media setting information;
a signal input unit, electrically connected to the central processing unit and including a plurality of media ports for receiving different digital video sources;
an audio/video (AV) output unit, electrically connected to the central processing unit for outputting a video signal;
a memory unit, electrically connected to the central processing unit for storing each of the channels in the composite channel table and media setting information thereof; and
an input/output (I/O) unit, electrically connected to the central processing unit for receiving a control command sent by the remote control;
wherein when the remote control sends a number command, the central processing unit searches for the channel corresponding to the number command in the memory unit according to the number command and displays the channel on the display screen.

2. The digital set-top box of claim 1, wherein the video streaming application is installed in the memory unit using installation files thereof downloaded by the user from the web or stored in an external storage device.

3. The digital set-top box of claim 1, wherein when the central processing unit searches for the channel corresponding to the number command, the central processing unit, based on the number command, finds the media setting information to search for the channel that corresponds to the number command.

4. The digital set-top box of claim 1, wherein the media ports include:
a plurality of network ports, connected to an external network to download installation files;
a plurality of USB ports, respectively connected to an external storage device to store the installation files;
a digital television port, connected to an external antenna or a digital television signal source for receiving multiple wired or wireless television signals; and
a plurality of memory card slots for receiving flash memory cards.

5. The digital set-top box of claim 1, wherein the AV output unit comprises a plurality of digital signal output ports and a plurality of analog signal output ports; wherein the digital signal output ports are configured to output a digital AV signal, and the analog signal output ports are configured to output an analog AV signal.

6. The digital set-top box of claim 1, wherein the memory unit comprises a flash memory and a random access memory; wherein the flash memory stores the channels in the composite channel table and the media setting information thereof, and the random access memory temporarily stores input signals of connection ports of the signal input unit as a buffer for data buffering.

7. The digital set-top box of claim 1, wherein the I/O unit further comprises a wireless receiving module, a plurality of indicator lights, and a plurality of buttons; wherein the wireless receiving module receives control commands from the remote control, the plurality of indicator lights display an operation state of the central processing unit, and the plurality of buttons allow a user to manually set the channels in the composite channel table and the media setting information thereof.

8. The digital set-top box of claim 1, wherein the central processing unit provides an operation interface sent from the AV output unit and displayed on the display screen.
